(19) United States
(12) Patent Application Publication
(10) Pub. No.: US 2019/0311713 A1
(43) Pub. Date: Oct. 10, 2019

(54) SYSTEM AND METHOD TO FULFILL A SPEECH REQUEST

(71) Applicant: GM GLOBAL TECHNOLOGY OPERATIONS LLC, Detroit, MI (US)

(72) Inventors: Gaurav Talwar, Novi, MI (US); Scott D. Custer, Lake Orion, MI (US); Ramzi Abdelmoula, Whitby (CA)

(21) Appl. No.: 15/946,473

(22) Filed: Apr. 5, 2018

(51) Int. Cl. G10L 15/22; G10L 15/30; G10L 15/18

(52) U.S. Cl. CPC G10L 15/22; G10L 2015/223; G10L 15/1815; G10L 15/30

(57) ABSTRACT

One general aspect includes a vehicle including: a passenger compartment for a user; a sensor located in the passenger compartment, the sensor configured to obtain a speech request from the user; a memory configured to store a specific intent for the speech request; and a processor configured to at least facilitate: obtaining a speech request from the user; attempting to classify the specific intent for the speech request via a voice assistant; determining the voice assistant cannot classify the specific intent from the speech request; after determining the voice assistant cannot classify the specific intent, interpreting the specific intent via one or more natural language processing (NLP) methodologies; implementing the voice assistant to fulfill the speech request or accessing one or more personal assistants to fulfill the speech request or some combination thereof, after the one or more NLP methodologies has interpreted the specific intent.

Many vehicles, smart phones, computers, and/or other systems and devices utilize a voice assistant to provide information or other services in response to a user request. However, in certain circumstances, it may be desirable for improved processing and/or assistance of these user requests.

For example, when a user provides a request that the voice assistant does not recognize, the voice assistant will provide a fallback intent that lets the user know the voice assistant does not recognize the specific intent of the request and thus cannot fulfill such a request. This can cause the user to have to go to a separate on-line store/database to acquire new skillsets for their voice assistant or cause the user to directly access a separate personal assistant to fulfill the request. Such tasks can be frustrating for the user wanting their request fulfillment being completed in a timely manner. It would therefore be desirable to provide a system or method that allows a user to implement their voice assistant to fulfill a request even when the voice assistant does not initially recognize the specific intent behind such a request.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a vehicle including: a passenger compartment for a user; a sensor located in the passenger compartment, the sensor configured to obtain a speech request from the user; a memory configured to store a specific intent for the speech request; and a processor configured to at least facilitate: obtaining a speech request from the user; attempting to classify the specific intent for the speech request via a voice assistant; determining the voice assistant cannot classify the specific intent from the speech request; after determining the voice assistant cannot classify the specific intent, interpreting the specific intent via one or more natural language processing (NLP) methodologies; implementing the voice assistant to fulfill the speech request or accessing one or more personal assistants to fulfill the speech request or some combination thereof, after the one or more NLP methodologies has interpreted the specific intent. Other embodiments of this aspect include corresponding computer systems, apparatus, and computer programs recorded on one or more computer storage devices, each configured to perform the actions of the methods.

Implementations may include one or more of the following features. The vehicle further including generating one or more rulesets for the specific intent, where the one or more rulesets are configured to assist the voice assistant to classify the specific intent for one or more subsequent similar speech requests. The vehicle further including, applying one or more machine-learning methodologies to assist the voice assistant to classify the specific intent for one or more subsequent similar speech requests. The vehicle where the one or more personal assistants are from the group including: an owner's manual personal assistant, vehicle domain personal assistant, travel personal assistant, shopping personal assistant, and an entertainment personal assistant. The vehicle where the accessed one or more personal assistants includes an automated personal assistant that is part of a remote computer system. Implementations of the described techniques may include hardware, a method or process, or computer software on a computer-accessible medium.

One general aspect includes a method for fulfilling a speech request, the method including: obtaining, via a sensor, the speech request from a user; implementing a voice assistant, via a processor, to classify a specific intent for the speech request; when the voice assistant cannot classify the specific intent, via the processor, implementing one or more natural language processing (NLP) methodologies to interpret the specific intent; and based on the specific intent being interpreted by the one or more NLP methodologies, via the processor, accessing one or more personal assistants to fulfill the speech request or implementing the voice assistant to fulfill the speech request or some combination thereof. Other embodiments of this aspect include corresponding computer systems, apparatus, and computer programs recorded on one or more computer storage devices, each configured to perform the actions of the methods.

Implementations may include one or more of the following features. The method further including, after the specific intent is interpreted by the one or more NLP methodologies, via the processor, generating one or more rulesets for the specific intent, where the one or more rulesets are configured to assist the voice assistant to classify the specific intent for one or more subsequent similar speech requests. The method further including, after the specific intent is interpreted by the one or more NLP methodologies, via the processor, applying one or more machine-learning methodologies to assist the voice assistant to classify the specific intent for one or more subsequent similar speech requests. The method where: the user is disposed within a vehicle; and the processor is disposed within the vehicle, and implements the voice assistant and the one or more NLP methodologies within the vehicle. The method where: the user is disposed within a vehicle; and the processor is disposed within a remote server and implements the voice assistant and the one or more NLP methodologies from the remote server. The method where the one or more personal assistants are from the group including: an owner's manual personal assistant, vehicle domain personal assistant, travel personal assistant, shopping personal assistant, and an entertainment personal assistant. The method where the accessed one or more personal assistants includes an automated personal assistant that is part of a computer system. Implementations of the described techniques may include hardware, a method or process, or computer software on a computer-accessible medium.

One general aspect includes a system for fulfilling a speech request, the system including: a sensor configured to obtain a speech request from a user; a memory configured to store a language of a specific intent for the speech request; and a processor configured to at least facilitate: obtaining a speech request from the user; attempting to classify the specific intent for the speech request via a voice assistant; determining the voice assistant cannot classify the specific intent; after determining the voice assistant cannot classify the specific intent, interpreting the specific intent via one or more natural language processing (NLP) methodologies; implementing the voice assistant to fulfill the speech request or accessing one or more personal assistants to fulfill the speech request or some combination thereof, after the one or more NLP methodologies has interpreted the specific intent. Other embodiments of this aspect include corresponding computer systems, apparatus, and computer programs recorded on one or more computer storage devices, each configured to perform the actions of the methods.

Implementations may include one or more of the following features. The system further including generating one or more rulesets for the specific intent, where the one or more rulesets are configured to assist the voice assistant to classify the specific intent for one or more subsequent similar speech requests. The system further including, applying one or more machine-learning methodologies to assist the voice assistant to classify the specific intent for one or more subsequent similar speech requests. The system where: the user is disposed within a vehicle; and the processor is disposed within the vehicle, and implements the voice assistant and the one or more NLP methodologies within the vehicle. The system where: the user is disposed within a vehicle; and the processor is disposed within a remote server and implements the voice assistant and the one or more NLP methodologies from the remote server. The system where the one or more personal assistants are from the group including: an owner's manual personal assistant, vehicle domain personal assistant, travel personal assistant, shopping personal assistant, and an entertainment personal assistant. The system where the accessed one or more personal assistants includes an automated personal assistant that is part of a computer system. Implementations of the described techniques may include hardware, a method or process, or computer software on a computer-accessible medium.

### BRIEF DESCRIPTION OF THE DRAWINGS

The disclosed examples will hereinafter be described in conjunction with the following drawing figures, wherein like numerals denote like elements, and wherein:

FIG. 1 is a functional block diagram of a system that includes a vehicle, a remote server, various voice assistants, and a control system for utilizing a voice assistant to provide information or other services in response to a request from a user, in accordance with exemplary embodiments;

FIG. 2 is a block diagram depicting an embodiment of an automatic speech recognition (ASR) system that is capable of utilizing the system and method disclosed herein; and

FIG. 3 is a flowchart of a process for fulfilling a speech request from a user, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

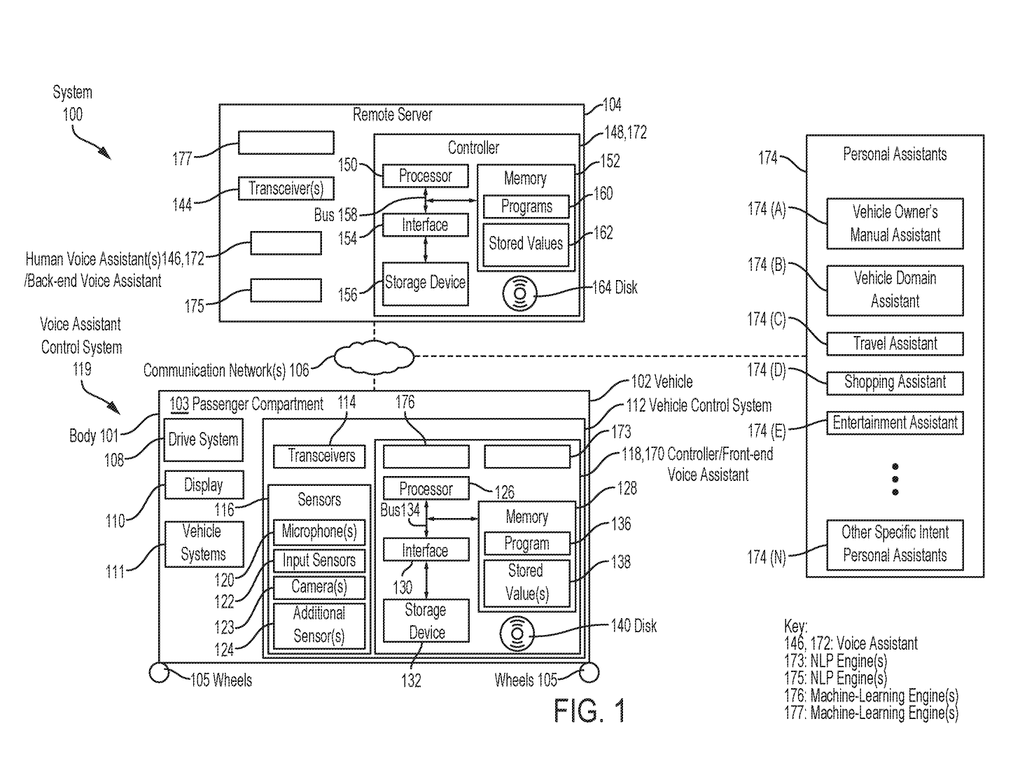

FIG. 1 illustrates a system 100 that includes a vehicle 102, a remote server 104, and various remote personal assistants 174(A)-174(N). In various embodiments, as depicted in FIG. 1, the vehicle 102 includes one or more frontend primary voice assistants 170 that are each a software-based agent that can perform one or more tasks for a user (often called a “chatbot”), one or more frontend natural language processing (NLP) engines 173, and one or more frontend machine-learning engines 176, and the remote server 104 includes one or more backend voice assistants 172 (similar to the frontend voice assistant 170), one or more backend NLP engines 175, and one or more backend machine-learning engines 177.

In certain embodiments, the voice assistant(s) provides information for a user pertaining to one or more systems of the vehicle 102 (e.g., pertaining to operation of vehicle cruise control systems, lights, infotainment systems, climate control systems, and so on). Also in certain embodiments, the voice assistant(s) provides information for a user pertaining to navigation (e.g., pertaining to travel and/or points of interest for the vehicle 102 while travelling). Also in certain embodiments, the voice assistant(s) provides information for a user pertaining to general personal assistance (e.g., pertaining to voice interaction, making to-do lists, setting alarms, music playback, streaming podcasts, playing audiobooks, other real-time information such as, but not limited to, weather, traffic, and news, and pertaining to one or more downloadable skills). In certain embodiments, both the frontend and backend NLP engine(s) 173, 175 utilize known NLP techniques/algorithms (i.e., a natural language understanding heuristic) to create one or more common-sense interpretations that correspond to language from a textual input. In certain embodiments, both the frontend and backend machine-learning engines 176, 177 utilize known statistics based modeling techniques/algorithms to build data over time to adapt the models and route information based on data insights (e.g., supervised learning, unsupervised learning, reinforcement learning algorithms, etc.).

Also in certain embodiments, secondary personal assistants 174 (i.e., other software-based agents for the performance of one or more tasks) may be configured with one or more specialized skillsets that can provide focused information for a user pertaining to one or more specific intents such as, by way of example, one or more vehicle owner's manual personal assistants 174(A) (e.g., providing information from one or more databases having instructional information pertaining to one or more vehicles) by way of, for instance, FEATURE TEACHER™, one or more vehicle domain assistants 174(B) (e.g., providing information from one or more databases having vehicle component information pertaining to one or more vehicles) by way of, for instance, GINA VEHICLE BOT™; one or more travel personal assistants 174(C) (e.g., providing information from one or more databases having various types of travel information) by way of, for instance, GOOGLE ASSISTANT™, SNAPTRAVEL™, HIPMUNK™, or KAYAK™; one or more shopping assistants 174(D) (e.g., providing information from one or more databases having various shopping/retail related information) by way of, for instance, GOOGLE SHOPPING™, SHOPZILLA™, or PRICEGRABBER™; and one or more entertainment assistants 174(E) (e.g., providing information from one or more databases having media related information) by way of, for instance, GOATBOT™, FACTPEDIA™, DAT BOT™. It will be appreciated that the number and/or type of personal assistants may vary in different embodiments (e.g., the use of lettering A . . . N for the additional personal assistants 174 may represent any number of voice assistants).

In various embodiments, each of the personal assistants 174(A)-174(N) is associated with one or more computer systems having a processor and a memory. Also in various embodiments, each of the personal assistants 174(A)-174(N) may include an automated voice assistant, messaging assistant, and/or a human voice assistant. In various embodiments, in the case of an automated voice assistant, an associated computer system makes the various determinations and fulfills the user requests on behalf of the automated voice assistant. Also in various embodiments, in the case of a human voice assistant (e.g., a human voice assistant 146 of the remote server 104, as shown in FIG. 1), an associated computer system provides information that may be used by a human in making the various determinations and fulfilling the requests of the user on behalf of the human voice assistant.

As depicted in FIG. 1, in various embodiments, the vehicle 102, the remote server 104, and the various personal assistants 174(A)-174(N) communicate via one or more communication networks 106 (e.g., one or more cellular, satellite, and/or other wireless networks, in various embodiments). In various embodiments, the system 100 includes one or more voice assistant control systems 119 for utilizing a voice assistant to provide information or other services in response to a request from a user.

In various embodiments, the vehicle 102 includes a body 101, a passenger compartment (i.e., cabin) 103 disposed within the body 101, one or more wheels 105, a drive system 108, a display 110, one or more other vehicle systems 111, and a vehicle control system 112. In various embodiments, the vehicle control system 112 of the vehicle 102 includes or is part of the voice assistant control system 119 for utilizing a voice assistant to provide information or other services in response to a request from a user, in accordance with exemplary embodiments. In various embodiments, the voice assistant control system 119 and/or components thereof may also be part of the remote server 104.

In various embodiments, the vehicle 102 includes an automobile. The vehicle 102 may be any one of a number of distinct types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the voice assistant control system 119 may be implemented in connection with one or more diverse types of vehicles, and/or in connection with one or more diverse types of systems and/or devices, such as computers, tablets, smart phones, and the like and/or software and/or applications therefor, and/or in one or more computer systems of or associated with any of the personal assistants 174(A)-174(N).

In various embodiments, the drive system 108 is mounted on a chassis (not depicted in FIG. 1), and drives the wheels 109. In various embodiments, the drive system 108 includes a propulsion system. In certain exemplary embodiments, the drive system 108 includes an internal combustion engine and/or an electric motor/generator, coupled with a transmission thereof. In certain embodiments, the drive system 108 may vary, and/or two or more drive systems 108 may be used. By way of example, the vehicle 102 may also incorporate any one of, or combination of, a number of distinct types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, the display 110 includes a display screen, speaker, and/or one or more associated apparatus, devices, and/or systems for providing visual and/or audio information, such as map and navigation information, for a user. In various embodiments, the display 110 includes a touch screen. Also in various embodiments, the display 110 includes and/or is part of and/or coupled to a navigation system for the vehicle 102. Also in various embodiments, the display 110 is positioned at or proximate a front dash of the vehicle 102, for example, between front passenger seats of the vehicle 102. In certain embodiments, the display 110 may be part of one or more other devices and/or systems within the vehicle 102. In certain other embodiments, the display 110 may be part of one or more separate devices and/or systems (e.g., separate or different from a vehicle), for example, such as a smart phone, computer, table, and/or other device and/or system and/or for other navigation and map-related applications.

Also in various embodiments, the one or more other vehicle systems 111 include one or more systems of the vehicle 102 for which the user may be requesting information or requesting a service (e.g., vehicle cruise control systems, lights, infotainment systems, climate control systems, and so on).

In various embodiments, the vehicle control system 112 includes one or more transceivers 114, sensors 116, and a controller 118. As noted above, in various embodiments, the vehicle control system 112 of the vehicle 102 includes or is part of the voice assistant control system 119 for utilizing a voice assistant to provide information or other services in response to a request from a user, in accordance with exemplary embodiments. In addition, similar to the discussion above, while in certain embodiments the voice assistant control system 119 (and/or components thereof) is part of the vehicle 102, in certain other embodiments the voice assistant control system 119 may be part of the remote server 104 and/or may be part of one or more other separate devices and/or systems (e.g., separate or different from a vehicle and the remote server), for example, such as a smart phone, computer, and so on, and/or any of the personal assistants 174(A)-174(N), and so on.

In various embodiments, the one or more transceivers 114 are used to communicate with the remote server 104 and the personal assistants 174(A)-174(N). In various embodiments, the one or more transceivers 114 communicate with one or more respective transceivers 144 of the remote server 104, and/or respective transceivers (not depicted) of the additional personal assistants 174, via one or more communication networks 106.

Also, as depicted in FIG. 1, the sensors 116 include one or more microphones 120, other input sensors 122, cameras 123, and one or more additional sensors 124. In various embodiments, the microphone 120 receives inputs from the user, including a request from the user (e.g., a request from the user for information to be provided and/or for one or more other services to be performed). Also in various embodiments, the other input sensors 122 receive other inputs from the user, for example, via a touch screen or keyboard of the display 110 (e.g., as to additional details regarding the request, in certain embodiments). In certain embodiments, one or more cameras 123 are utilized to obtain data and/or information pertaining to point of interests and/or other types of information and/or services of interest to the user, for example, by scanning quick response (QR) codes to obtain names and/or other information pertaining to points of interest and/or information and/or services requested by the user (e.g., by scanning coupons for preferred restaurants, stores, and the like, and/or scanning other materials in or around the vehicle 102, and/or intelligently leveraging the cameras 123 in a speech and multi modal interaction dialog), and so on.

In addition, in various embodiments, the additional sensors 124 obtain data pertaining to the drive system 108 (e.g., pertaining to operation thereof) and/or one or more other vehicle systems 111 for which the user may be requesting information or requesting a service (e.g., vehicle cruise control systems, lights, infotainment systems, climate control systems, and so on).

In various embodiments, the controller 118 is coupled to the transceivers 114 and sensors 116. In certain embodiments, the controller 118 is also coupled to the display 110, and/or to the drive system 108 and/or other vehicle systems 111. Also in various embodiments, the controller 118 controls operation of the transceivers and sensors 116, and in certain embodiments also controls, in whole or in part, the drive system 108, the display 110, and/or the other vehicle systems 111.

In various embodiments, the controller 118 receives inputs from a user, including a request from the user for information (i.e., a speech request) and/or for the providing of one or more other services. Also in various embodiments, the controller 118 communicates with frontend voice assistant 170 or backend voice assistant 172 via the remote server 104. Also in various embodiments, voice assistant 170/172 will identify and classify the specific intent behind the user request and subsequently fulfill the user request via one or more embedded skills or, in certain instances, determine which of the personal assistants 174(A)-174(N) to access for support or to have independently fulfill the user request based on the specific intent.

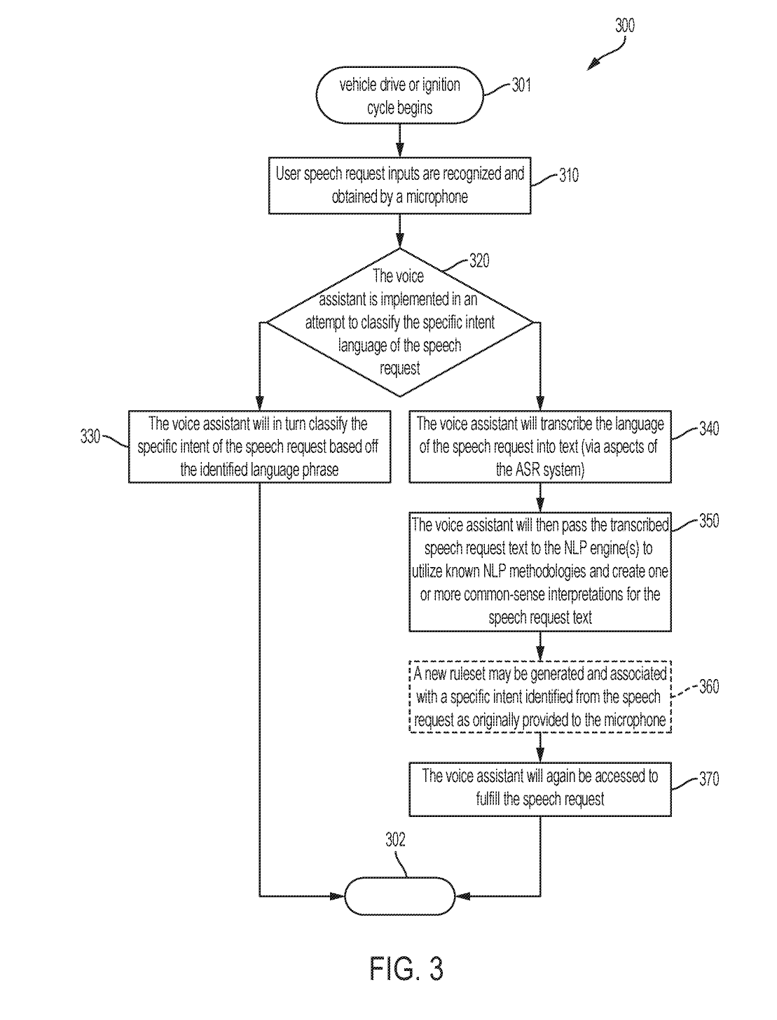

Also in various embodiments, if the voice assistant 170/172 cannot readily classify the specific intent behind the language of a user request and thus fulfill the user request (i.e., the user request receives a fallback intent classification), the voice assistant 170/172 will implement aspects of its automatic speech recognition (ASR) system, discussed below, to convert the language of the speech request into text and pass the transcribed speech to the NLP engine 173/175 for additional support. Also in various embodiments, the NLP engine 173/175 will implement natural language techniques to create one or more common-sense interpretations for the transcribed speech language, classify the specific intent based on at least one of those common-sense interpretations and, if the specific intent can be classified, the voice assistant 170/172 and/or an appropriate personal assistant 174(A)-174(N) will be accessed to handle and fulfill the request. Also, in various embodiments, rulesets may be generated and/or the machine-learning engine 176/177 may be implemented to assist the voice assistant 170/172 in classifying the specific intent behind subsequent user request of a similar nature. Also in various embodiments, the controller 118 performs these tasks in an automated manner in accordance with the steps of the process 300 described further below in connection with FIG. 3. In certain embodiments, some or all of these tasks may also be performed in whole or in part by one or more other controllers, such as the remote server controller 148 (discussed further below) and/or one or more controllers (not depicted) of the additional personal assistants 174, instead of or in addition to the vehicle controller 118.

The controller 118 includes a computer system. In certain embodiments, the controller 118 may also include one or more transceivers 114, sensors 116, other vehicle systems and/or devices, and/or components thereof. In addition, it will be appreciated that the controller 118 may otherwise differ from the embodiment depicted in FIG. 1. For example, the controller 118 may be coupled to or may otherwise utilize one or more remote computer systems and/or other control systems, for example, as part of one or more of the above-identified vehicle 102 devices and systems, and/or the remote server 104 and/or one or more components thereof, and/or of one or more devices and/or systems of or associated with the additional personal assistants 174.

In the depicted embodiment, the computer system of the controller 118 includes a processor 126, a memory 128, an interface 130, a storage device 132, and a bus 134. The processor 126 performs the computation and control functions of the controller 118, and may comprise any type of processor or multiple processors, single integrated circuits such as a microprocessor, or any suitable number of integrated circuit devices and/or circuit boards working in cooperation to accomplish the functions of a processing unit. During operation, the processor 126 executes one or more programs 136 contained within the memory 128 and, as such, controls the general operation of the controller 118 and the computer system of the controller 118, generally in executing the processes described herein, such as the process 300 described further below in connection with FIG. 3.

The memory 128 can be any type of suitable memory. For example, the memory 128 may include various types of dynamic random-access memory (DRAM) such as SDRAM, the various types of static RAM (SRAM), and the various types of non-volatile memory (PROM, EPROM, and flash). In certain examples, the memory 128 is located on and/or co-located on the same computer chip as the processor 126. In the depicted embodiment, the memory 128 stores the above-referenced program 136 along with one or more stored values 138 (e.g., in various embodiments, a database of specific skills associated with each of the different personal assistants 174(A)-174(N)).

The bus 134 serves to transmit programs, data, status and other information or signals between the various components of the computer system of the controller 118. The interface 130 allows communication to the computer system of the controller 118, for example, from a system driver and/or another computer system, and can be implemented using any suitable method and apparatus. In one embodiment, the interface 130 obtains the various data from the transceiver 114, sensors 116, drive system 108, display 110, and/or other vehicle systems 111, and the processor 126 provides control for the processing of the user requests based on the data. In various embodiments, the interface 130 can include one or more network interfaces to communicate with other systems or components. The interface 130 may also include one or more network interfaces to communicate with technicians, and/or one or more storage interfaces to connect to storage apparatuses, such as the storage device 132.

The storage device 132 can be any suitable type of storage apparatus, including direct access storage devices such as hard disk drives, flash systems, floppy disk drives and optical disk drives. In one exemplary embodiment, the storage device 132 includes a program product from which memory 128 can receive a program 136 that executes one or more embodiments of one or more processes of the present disclosure, such as the steps of the process 300 (and any sub-processes thereof) described further below in connection with FIG. 3. In another exemplary embodiment, the program product may be directly stored in and/or otherwise accessed by the memory 128 and/or a disk (e.g., disk 140), such as that referenced below.

The bus 134 can be any suitable physical or logical means of connecting computer systems and components. This includes, but is not limited to, direct hard-wired connections, fiber optics, infrared and wireless bus technologies. During operation, the program 136 is stored in the memory 128 and executed by the processor 126.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 126) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 118 may also otherwise differ from the embodiment depicted in FIG. 1, for example, in that the computer system of the controller 118 may be coupled to or may otherwise utilize one or more remote computer systems and/or other control systems.

Also, as depicted in FIG. 1, in various embodiments the remote server 104 includes a transceiver 144, one or more human voice assistants 146, and a remote server controller 148. In various embodiments, the transceiver 144 communicates with the vehicle control system 112 via the transceiver 114 thereof, using the one or more communication networks 106.

In addition, as depicted in FIG. 1, in various embodiments the remote server 104 includes a voice assistant 172, discussed above in detail, associated with one or more computer systems of the remote server 104 (e.g., controller 148). In certain embodiments, the remote server 104 includes an automated voice assistant 172 that provides automated information and services for the user via the controller 148. In certain other embodiments, the remote server 104 includes a human voice assistant 146 that provides information and services for the user via a human being, which also may be facilitated via information and/or determinations provided by the controller 148 coupled to and/or utilized by the human voice assistant 146.

Also in various embodiments, the remote server controller 148 helps to facilitate the processing of the request and the engagement and involvement of the human voice assistant 146, and/or may serve as an automated voice assistant. As used throughout this Application, the term “voice assistant” refers to any number of distinct types of voice assistants, voice agents, virtual voice assistants, and the like, that provide information to the user upon request. For example, in various embodiments, the remote server controller 148 may comprise, in whole or in part, the voice assistant control system 119 (e.g., either alone or in combination with the vehicle control system 112 and/or similar systems of a user's smart phone, computer, or other electronic device, in certain embodiments). In certain embodiments, the remote server controller 148 may perform some or all of the processing steps discussed below in connection with the controller 118 of the vehicle 102 (either alone or in combination with the controller 118 of the vehicle 102) and/or as discussed in connection with the process 300 of FIG. 3.

In addition, in various embodiments, the remote server controller 148 includes a processor 150, a memory 152 with one or more programs 160 and stored values 162 stored therein, an interface 154, a storage device 156, a bus 158, and/or a disk 164 (and/or other storage apparatus), similar to the controller 118 of the vehicle 102. Also in various embodiments, the processor 150, the memory 152, programs 160, stored values 162, interface 154, storage device 156, bus 158, disk 164, and/or other storage apparatus of the remote server controller 148 are similar in structure and function to the respective processor 126, memory 128, programs 136, stored values 138, interface 130, storage device 132, bus 134, disk 140, and/or other storage apparatus of the controller 118 of the vehicle 102, for example, as discussed above.

As noted above, in various embodiments, the various personal assistants 174(A)-174(N) may provide information for specific intents, such as, by way of example, one or vehicle owner's manual assistant 174(A); vehicle domain assistants 174(B); travel assistants 174(C); shopping assistants 174(D); entertainment assistants 174(E); and/or any number of other specific intent personal assistants 174(N) (e.g., pertaining to any number of other user needs and desires).

It will also be appreciated that in various embodiments each of the additional personal assistants 174 may include, be coupled with and/or associated with, and/or may utilize various respective devices and systems similar to those described in connection with the vehicle 102 and the remote server 104, for example, including respective transceivers, controllers/computer systems, processors, memory, buses, interfaces, storage devices, programs, stored values, human voice assistant, and so on, with similar structure and/or function to those set forth in the vehicle 102 and/or the remote server 104, in various embodiments. In addition, it will further be appreciated that in certain embodiments such devices and/or systems may comprise, in whole or in part, the personal assistant control system 119 (e.g., either alone or in combination with the vehicle control system 112, the remote server controller 148, and/or similar systems of a user's smart phone, computer, or other electronic device, in certain embodiments), and/or may perform some or all of the processing steps discussed in connection with the controller 118 of the vehicle 102, the remote server controller 148, and/or in connection with the process 300 of FIG. 3.

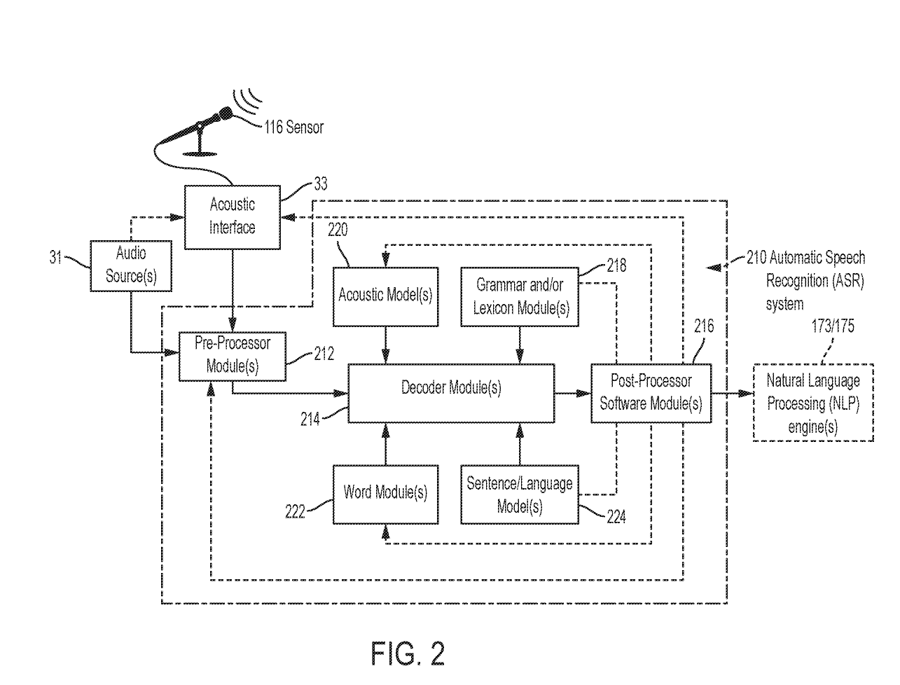

Turning now to FIG. 2, there is shown an exemplary architecture for an automatic speech recognition system (ASR) system 210 that can be used to enable the presently disclosed method. The ASR system 210 can be incorporated into any client device, such as those discussed above, including frontend voice assistant 170 and backend voice assistant 172. An ASR system that is similar or the same to ASR system 210 can be incorporated into one or more remote speech processing servers, including one or more servers located in one or more computer systems of or associated with any of the personal assistants 174(A)-174(N). In general, a vehicle occupant vocally interacts with an ASR system for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific exemplary ASR system 210. The system 210 includes a sensor to receive speech such as the vehicle microphone 120, and an acoustic interface 33 such as a sound card having an analog to digital converter to digitize the speech into acoustic data. The system 210 also includes a memory such as the memory 128 for storing the acoustic data and storing speech recognition software and databases, and a processor such as the processor 126 to process the acoustic data. The processor functions with the memory and in conjunction with the following modules: one or more front-end processors, pre-processors, or pre-processor software modules 212 for parsing streams of the acoustic data of the speech into parametric representations such as acoustic features; one or more decoders or decoder software modules 214 for decoding the acoustic features to yield digital subword or word output data corresponding to the input speech utterances; and one or more back-end processors, post-processors, or post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a lexicon or grammar can define a universe of vocabulary the system 210 expects at any given time in any given ASR mode. For example, if the system 210 is in a training mode for training commands, then the lexicon or grammar model(s) 218 can include all commands known to and used by the system 210. In another example, if the system 210 is in a main menu mode, then the active lexicon or grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative exemplary embodiment, some or all of the ASR system 210 can be resident on, and processed using, computing equipment in a location remote from the vehicle 102 such as the remote server 104. For example, grammar models, acoustic models, and the like can be stored in memory 152 of one of the remote server controller 148 and/or storage device 156 in the remote server 104 and communicated to the vehicle telematics unit 30 for in-vehicle speech processing. Similarly, speech recognition software can be processed using processors of one of the servers 82 in the call center 20. In other words, the ASR system 210 can be resident in the vehicle 102 or distributed across the remote server 104, and/or resident in one or more computer systems of or associated with any of the personal assistants 174(A)-174(N).

First, acoustic data is extracted from human speech wherein a vehicle occupant speaks into the microphone 120, which converts the utterances into electrical signals and communicates such signals to the acoustic interface 33. A sound-responsive element in the microphone 120 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 126 executes the pre-processor module(s) 212 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian MINI process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The MINI can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference pattern is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Exemplary parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems such as, for example, one or more NLP engines 173/175. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

FIG. 3 is a flowchart of a process for fulfilling a speech request having specific intent language that cannot initially be classified by a voice assistant 170/172, in accordance with exemplary embodiments. The process 200 can be implemented in connection with the vehicle 102 and the remote server 104, and various components thereof (including, without limitation, the control systems and controllers and components thereof), in accordance with exemplary embodiments.

With reference to FIG. 3, the process 300 begins at step 301. In certain embodiments, the process 300 begins when a vehicle drive or ignition cycle begins, for example, when a driver approaches or enters the vehicle 102, or when the driver turns on the vehicle and/or an ignition therefor (e.g. by turning a key, engaging a keyfob or start button, and so on). In certain embodiments, the process 300 begins when the vehicle control system 112 (e.g., including the microphone 120 or other input sensors 122 thereof), and/or the control system of a smart phone, computer, and/or other system and/or device, is activated. In certain embodiments, the steps of the process 300 are performed continuously during operation of the vehicle (and/or of the other system and/or device).

In various embodiments, personal assistant data is registered in this step. In various embodiments, respective skillsets of the different personal assistants 174(A)-174(N) are obtained, for example, via instructions provided by one or more processors (such as the vehicle processor 126, the remote server processor 150, and/or one or more other processors associated with any of the personal assistants 174(A)-174(N)). Also, in various embodiments, the specific intent language data corresponding to the respective skillsets of the different personal assistants 174(A)-174(N) are stored in memory (e.g., as stored database values 138 in the vehicle memory 128, stored database values 162 in the remote server memory 152, and/or one or more other memory devices associated with any of the personal assistants 174(A)-174(N)).

In various embodiments, user speech request inputs are recognized and obtained by microphone 120 (step 310). The speech request may include a Wake-Up-Word directly or indirectly followed by the request for information and/or other services. For example, a Wake-Up-Word is a speech command made by the user that allows the voice assistant to realize activation (i.e., to wake up the system while in a sleep mode). For example, in various embodiments, a Wake-Up-Word can be “HELLO SIRI” or, more specifically, the word “HELLO” (i.e., when the Wake-Up-Word is in the English language).

In addition, for example, in various embodiments, the speech request includes a specific intent which pertains to a request for information/services and regards a particular desire of the user to be fulfilled such as, but not limited to, a point of interest (e.g., restaurant, hotel, service station, tourist attraction, and so on), a weather report, a traffic report, to make a telephone call, to send a message, to control one or more vehicle functions, to obtain home-related information or services, to obtain audio-related information or services, to obtain mobile phone-related information or services, to obtain shopping-related information or servicers, to obtain web-browser related information or services, and/or to obtain one or more other types of information or services.

In certain embodiments, other sensor data is obtained. For example, in certain embodiments, the additional sensors 124 automatically collect data from or pertaining to various vehicle systems for which the user may seek information, or for which the user may wish to control, such as one or more engines, entertainment systems, climate control systems, window systems of the vehicle 102, and so on.

In various embodiments, the voice assistant 170/172 is implemented in an attempt to classify the specific intent language of the speech request (step 320). To classify the specific intent language, a specific intent language look-up table (“specific intent language database”) can also be retrieved. In various embodiments, the specific intent language database includes various types of exemplary language phrases to assist/enable the specific intent classification, such as, but not limited to, those equivalent to the following: “REACH OUT TO” (pertaining to making a phone call), “TURN UP THE SOUND” (pertaining to enhancing speaker volume), “BUY ME A” (pertaining to the purchasing of goods), “LET'S DO THIS” (pertaining to the starting of one or more tasks), “WHAT'S GOING ON WITH” (pertaining to a question about an event), “LET'S WATCH” (pertaining to a request to change a television station). Also in various embodiments, the specific intent language database is stored in the memory 128 (and/or the memory 152, and/or one or more other memory devices) as stored values thereof, and is automatically retrieved by the processor 126 during step 320 (and/or by the processor 150, and/or one or more other processors).

In certain embodiments, the specific intent language database includes data and/or information regarding previously used language/language phonemes of the user (user language history) based on a highest frequency of usage based on the usage history of the user, and so on. In certain embodiments, for example, in this way, the machine-learning engines 176/177 can be implemented to utilize known statistics based modeling methodologies to build guidelines/directives for certain specific intent language phrases. Thus, to assist voice assistant 170/172 to classify the specific intent in future speech requests (i.e., subsequent similar speech requests).

When the voice assistant 170/172 can identify a language phrase in the specific intent language database, the voice assistant 170/172 will in turn classify the specific intent of the speech request based off the identified language phrase (step 330). The voice assistant 170/172 will then review a ruleset associated with the language phrase to fulfill the speech request. In particular, these associated rulesets provide one or more hard-coded if-then rules which can provide precedent for the fulfillment of a speech request. In various embodiments, for example, voice assistant 170/172 will fulfill the speech request independently (i.e., by using embedded skills unique to the voice assistant), for example, fulfillment of navigation or general personal assistance requests. In various embodiments, for example, voice assistant 170/172 can fulfill the speech request with support skills from one or more personal assistants 174(A)-174(N). In various embodiments, for example, voice assistant 170/172 will pass the speech request to the one or more personal assistants 174(A)-174(N) for fulfillment (i.e., when the skills are beyond the scope of those embedded in the voice assistant 170/172). Skilled artists will also see one or more other combinations of voice assistant 170/172 and one or more personal assistants 174(A)-174(N) can fulfill the speech request. Upon fulfillment of the speech request, the method will move to completion 302.

When it is determined that language phrase cannot be found in the specific intent language database, and thus the voice assistant 170/172 cannot classify a specific intent of the speech request, the voice assistant 170/172 will transcribe the language of the speech request into text (via aspects of the ASR system 210) (step 340). The voice assistant 170/172 will then pass the transcribed speech request text to the NLP engine(s) 173/175 to utilize known NLP methodologies and create one or more common-sense interpretations for the speech request text (step 350). For example, if the transcribed speech request states: “HELLO SIRI, HOW MUCH CHARGE DO I HAVE ON MY CHEVY BOLT?”, the NLP engine(s) 173/175 can convert the language to “HELLO SIRI, WHAT IS THE REMAINING BATTERY LIFE FOR MY CHEVY BOLT.” Moreover, the NLP engine(s) 173/175 can be configured to recognize and strip the language corresponding to the Wake-Up-Word (i.e., “HELLO, SIRI”) and the language corresponding to the entity (i.e., “MY CHEVY BOLT”) and any other unnecessary language from the speech request text to end with common-sense-interpreted specific intent language from the transcribed speech request (i.e., remaining with “WHAT IS THE REMAINING BATTERY LIFE”). The specific intent language database can again be retrieved to identify a language phrase and associated ruleset for the classification of the transcribed common-sense specific intent.

In various embodiments, after the specific intent has been classified, a new ruleset may be generated and associated with a specific intent identified from the speech request as originally provided to the microphone (i.e., “HOW MUCH CHARGE DO I HAVE”) (optional step 360). For example, the ruleset may correspond the original specific intent language with the common-sense interpretation language for the specific intent that has been converted by the NLP engine(s) 173/175 (i.e., “HOW MUCH CHARGE DO I HAVE”=“WHAT IS THE REMAINING BATTERY LIFE”). This newly generated ruleset may also be stored in specific intent language database so that voice assistant 170/172 can classify this specific intent in future speech requests (i.e., any subsequent speech requests that similarly ask: “HOW MUCH CHARGE DO I HAVE ON MY CHEVY BOLT?”). In various embodiment, alternatively or additionally in this optional step, one or more statistics-based modeling algorithms can be deployed, via the machine-learning engines 176/177, to assist voice assistant 170/172 to classify the specific intent in future speech requests.

In various embodiments, after the specific intent has been classified, voice assistant 170/172 will again be accessed to fulfill the speech request (step 370). In various embodiments, voice assistant 170/172 will fulfill the speech request independently (e.g., via one or more of the embedded skills). In various embodiments, voice assistant 170/172 can fulfill the speech request with support from one or more personal assistants 174(A)-174(N). In various embodiments, at least one of the one or more personal assistants 174(A)-174(N) can be accessed to fulfill the speech request independently. Skilled artists will also see one or more other combinations of voice assistant 170/172 and one or more personal assistants 174(A)-174(N) can fulfill the speech request. In the example above the specific intent “HOW MUCH CHARGE DO I HAVE” can be classified to correspond to a ruleset that causes the vehicle domain personal assistant 174(B) to be accessed to provide State of Charge (SoC) information for vehicle 102. Upon fulfillment of the speech request, the method will move to completion 302.

Accordingly, the systems, vehicles, and methods described herein provide for potentially improved processing of user request, for example, for a user of a vehicle. Based on an identification of the nature of the user request and a comparison with various respective skills of a plurality of diverse types of voice assistants, the user's request is routed to the most appropriate voice assistant.

The systems, vehicles, and methods thus provide for a potentially improved and/or efficient experience for the user in having his or her requests processed by the most accurate and/or efficient voice assistant tailored to the specific user request. As noted above, in certain embodiments, the techniques described above may be utilized in a vehicle. Also, as noted above, in certain other embodiments, the techniques described above may also be utilized in connection with the user's smart phones, tablets, computers, other electronic devices and systems.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A vehicle comprising:
a passenger compartment for a user;
a sensor located in the passenger compartment, the sensor configured to obtain a speech request from the user;
a memory configured to store a specific intent for the speech request; and
a processor configured to at least facilitate:
obtaining a speech request from the user;
attempting to classify the specific intent for the speech request via a voice assistant;
determining the voice assistant cannot classify the specific intent from the speech request;
after determining the voice assistant cannot classify the specific intent, creating one or more common-sense interpretations that correspond to the specific intent via one or more natural language processing (NLP) methodologies;
classifying the specific intent from the at least one of the one or more common-sense interpretations, wherein a specific intent language database is retrieved to classify the specific intent from the at least one of the one or more common-sense interpretations; and
accessing one or more automated personal assistants to fulfill the speech request, after the specific intent has been classified from the at least one of the one or more common-sense interpretations, wherein the one or more personal assistants are stored in a server remotely located from the vehicle, wherein each of the one or more personal assistants are configured to include a specialized skillset that can provide focused information that pertains to the specific intent.

2. The vehicle of claim 1, further comprising generating one or more rulesets for the specific intent, wherein the one or more rulesets are configured to assist the voice assistant to classify the specific intent for one or more subsequent similar speech requests.

3. The vehicle of claim 1, further comprising, applying one or more machine-learning methodologies to assist the voice assistant to classify the specific intent for one or more subsequent similar speech requests.

4. The vehicle of claim 1, wherein the one or more personal assistants are from the group comprising: an owner's manual personal assistant that provides information from one or more databases having instructional information pertaining to one or more vehicles, vehicle domain personal assistant that provides information from one or more databases having vehicle component information pertaining to one or more vehicles, travel personal assistant that provides information from one or more databases having various types of travel information, shopping personal assistant that provides information from one or more databases having various retail related information, and an entertainment personal assistant that provides information from one or more databases having media related information.

5. (canceled)

6. A method for fulfilling a speech request, the method comprising:
obtaining, via a sensor, the speech request from a user;
implementing a voice assistant, via a processor, to classify a specific intent for the speech request;
when the voice assistant cannot classify the specific intent, via the processor, implementing one or more natural language processing (NLP) methodologies to create one or more common-sense interpretations that correspond to the specific intent;
classify the specific intent from the at least one of the one or more common-sense interpretations, wherein a specific intent language database is retrieved to classify the specific intent from the at least one of the one or more common-sense interpretations; and
based on the specific intent being classified from the at least one of the one or more common-sense interpretations, via the processor, accessing one or more automated personal assistants to fulfill the speech request, wherein the one or more personal assistants are stored in a server remotely located from the vehicle, wherein each of the one or more personal assistants are configured to include a specialized skillset that can provide focused information that pertains to the specific intent.

7. The method of claim 6, further comprising, after the specific intent is interpreted by the one or more NLP methodologies, via the processor, generating one or more rulesets for the specific intent, wherein the one or more rulesets are configured to assist the voice assistant to classify the specific intent for one or more subsequent similar speech requests.

8. The method of claim 6, further comprising, after the specific intent is interpreted by the one or more NLP methodologies, via the processor, applying one or more machine-learning methodologies to assist the voice assistant to classify the specific intent for one or more subsequent similar speech requests.

9. The method of claim 6, wherein:
the user is disposed within a vehicle; and
the processor is disposed within the vehicle, and implements the voice assistant and the one or more NLP methodologies within the vehicle.

10. The method of claim 6, wherein:
the user is disposed within a vehicle; and
the processor is disposed within a remote server and implements the voice assistant and the one or more NLP methodologies from the remote server.

11. The method of claim 6, wherein the one or more personal assistants are from the group comprising: an owner's manual personal assistant that provides information from one or more databases having instructional information pertaining to one or more vehicles, vehicle domain personal assistant that provides information from one or more databases having vehicle component information pertaining to one or more vehicles, travel personal assistant that provides information from one or more databases having various types of travel information, shopping personal assistant that provides information from one or more databases having various retail related information, and an entertainment personal assistant that provides information from one or more databases having media related information.

12. (canceled)

13. A system for fulfilling a speech request, the system comprising:
a sensor configured to obtain the speech request from a user;
a memory configured to store a language of a specific intent for the speech request; and
a processor configured to at least facilitate:
obtaining a speech request from the user;
attempting to classify the specific intent for the speech request via a voice assistant;
determining the voice assistant cannot classify the specific intent;
after determining the voice assistant cannot classify the specific intent, creating one or more common-sense interpretations that correspond to the specific intent via one or more natural language processing (NLP) methodologies;
classifying the specific intent from the at least one of the one or more common-sense interpretations, wherein a specific intent language database is retrieved to classify the specific intent from the at least one of the one or more common-sense interpretations; and
accessing one or more automated personal assistants to fulfill the speech request, after the the specific intent has been classified from the at least one of the one or more common-sense interpretations, wherein the one or more personal assistants are stored in a server remotely located from the vehicle, wherein each of the one or more personal assistants are configured to include a specialized skillset that can provide focused information that pertains to the specific intent.

14. The system of claim 13, further comprising generating one or more rulesets for the specific intent, wherein the one or more rulesets are configured to assist the voice assistant to classify the specific intent for one or more subsequent similar speech requests.

15. The system of claim 13, further comprising, applying one or more machine-learning methodologies to assist the voice assistant to classify the specific intent for one or more subsequent similar speech requests.

16. The system of claim 13, wherein:
the user is disposed within a vehicle; and
the processor is disposed within the vehicle, and implements the voice assistant and the one or more NLP methodologies within the vehicle.

17. The system of claim 13, wherein:
the user is disposed within a vehicle; and
the processor is disposed within a remote server and implements the voice assistant and the one or more NLP methodologies from the remote server.

18. The system of claim 13, wherein the one or more personal assistants are from the group comprising: an owner's manual personal assistant that provides information from one or more databases having instructional information pertaining to one or more vehicles, vehicle domain personal assistant that provides information from one or more databases having vehicle component information pertaining to one or more vehicles, travel personal assistant that provides information from one or more databases having various types of travel information, shopping personal assistant that provides information from one or more databases having various retail related information, and an entertainment personal assistant that provides information from one or more databases having media related information.

19. (canceled)
